(19) United States
(12) Patent Application Publication
(10) Pub. No.: US 2003/0109279 A1
(43) Pub. Date: Jun. 12, 2003

(54) Method and apparatus for processing radio frequency signals in a tri-mode mobile terminal

(75) Inventor: Won-Hyung Park, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/214,779

(22) Filed: Aug. 9, 2002

(30) Foreign Application Priority Data
Dec. 10, 2001 (KR) 77931/2001

(51) Int. Cl. H04B 1/38

(52) U.S. Cl. 455/553; 455/552; 455/550; 455/575

(57) ABSTRACT

An apparatus including a first mixer, a second mixer, an oscillator, and a frequency divider. The oscillator is coupled to the first mixer, for processing a signal of a first communication protocol. The frequency divider comprises an input and an output. The input of the divider is coupled to the oscillator and the output of the divider is coupled to the second mixer. The second mixer is for processing a signal of a second communication standard. The embodiments of the present invention are advantageous, as a single oscillator can be utilized for driving both a first mixer and second mixer at different frequencies. Accordingly, separate oscillators are not needed for the first mixer and the second mixer. These embodiments simplify the circuit structure of a tri-mode mobile terminal and consequently allow for tri-mode mobile terminals to have a smaller size and weight.

### BACKGROUND OF THE INVENTION

1. Field of the Invention

The present invention relates to a tri-mode mobile terminal, and particularly, to a method and an apparatus for processing a radio frequency (RF) signal in the tri-mode mobile terminal.

2. Background of the Related Art

Mobile terminals, also known as mobile phones, cell phones, or wireless phones, are popular devices used for communication. Users of mobile terminals generally prefer for these devices to be as small and lightweight as possible. Users also typically desire their mobile terminal to be compatible in different wireless communication networks. Accordingly, tri-mode mobile terminals have been developed that can communicate in different types of wireless networks. However, these tri-mode mobile terminals tend to be relatively heavy and of a large size due to the necessity of separate hardware components to accommodate for the different wireless networks.

For example, a tri-mode mobile terminal can be operated in AMPS (Advanced Mobile Phone System) service mode, in CDMA (Code Division Multiple Access) service mode, and PCS (Personal Communications System) service mode.

FIG. 1 illustrates a background apparatus for processing a radio frequency signal in a tri-mode mobile terminal. Separator 2 is for separating a radio frequency signal from antenna 1 according to AMPS mode/CDMA mode (hereinafter, referred to as Digital Communication Network mode) and PCS modes. Digital Communication Network (DCN) duplexer 3 which is connected to the separator 2 is for separating a RF transmission signal and RF receive signal of the DCN mode. PCS duplexer 4, connected to separator 2, is for separating a RF transmission signal and RF receive signal in PCS mode.

Tri-mode RF (Radio Frequency) receive processing unit 10 is for receive processing the RF signal. A RF signal in DCN mode is separated in the DCN duplexer 3 and a RF signal in PCS mode is separated in the PCS duplexer 4. Tri-mode IF (Intermediate Frequency) receive processing unit 20 is for processing an IF signal. An IF signal is lowered in frequency in the tri-mode RF receive processing unit 10 to a base band signal. Base band module 30 is for changing the analog base band signal received from the tri-mode IF receive processing unit 20 to a digital signal.

Tri-mode IF transmission processing unit 40 is for changing the analog base band signal transmitted from the base band module 30 into an IF transmission signal regardless of its mode. Tri-mode RF transmission processing unit 50 is for changing the IF transmission signal processed in the tri-mode IF transmission processing unit 40 into the RF transmission signal in DCN mode and PCS mode. First RF voltage controlled oscillator (VCO) 61 is for providing a carrier frequency according to DCN mode to the tri-mode RF receive processing unit 10 and the tri-mode RF transmission processing unit 50. Second RF VCO 62 is for providing tri-mode RF receive processing unit 10 and tri-mode RF transmission processing unit 50 with a carrier frequency according to PCS mode. RF phase locked loop (PLL) 60 is for controlling the first VCO 61 and the second VCO 62 so that the output frequency of the first and second VCOs 61 and 62 are operated at a certain phase angle.

Tri-mode RF receive processing unit 10 includes first low noise amplifier (LNA) 11, first receive RF mixer 12, a second LNA 13, and a second receive RF mixer 14. First LNA 11 is for eliminating noise of the RF receive signal in the DCN mode received from the DCN duplexer 3 and amplifying the signal. First receive RF mixer 12 is for mixing the RF receive signal of the DCN mode outputted from the first LNA 11 and the carrier frequency outputted from the first RF VCO 61. Second LNA 13 is for eliminating noise of the RF receive signal of the PCS mode which is separated in the PCS duplexer 4. Second receive RF mixer 14 is for mixing the RF receive signal of the PCS mode outputted from the second LNA 13 and the carrier frequency outputted from the second RF VCO 62.

Tri-mode RF receive processing unit 20 includes a receive IF automatic gain controller (RX IF AGC) 21, a receive IF VCO (RX IF VCO) 23, a receive IF PLL (RX IF PLL) 22, a first RX IF mixer 24, and a second RX IF mixer 25. RX IF AGC 21 is for automatically controlling the magnitude of the IF receive signal of the DCN mode and of the IF receive signal of the PCS mode outputted from the first and second receive RF mixers 12 and 14. Receive IF VCO (RX IF VCO) 23, outputting the IF, is for changing the IF receive signal outputted from the RX IF AGC 21 into an analog signal of the base band according to the corresponding modes. Receive IF PLL (RX IF PLL) 22 is for controlling the RX IF VCO 23 so that the output frequency of the RX IF VCO 23 is operated at a certain phase angle. First RX IF mixer 24 is for mixing the IF receive signal of the DCN mode outputted from the RX IF AGC 21 and the IF(DCN_RX_IF) of the DCN mode outputted from the RX IF VCO 23. Second RX IF mixer 25 is for mixing the IF receive signal of the PCS mode outputted from the RX IF AGC 21 and the IF(PCS_RX₁₃ IF) of the PCS mode outputted from the RX IF VCO 23.

Tri-mode IF transmission processing unit 40 includes a transmission IF VCO (TX IF VCO) 42, a TX IF PLL 41, a transmission IF mixer 43, and a transmission IF AGC 44. TX IF VCO 42, outputting an IF, is for changing the base band signal transmitted from the base band module 30 into the IF transmission signal. TX IF PLL 41 is for controlling the transmission IF VCO 42 so that the output frequency of the transmission IF VCO 42 is operated at a certain phase angle. Transmission IF mixer 43 is for mixing an IF (transmission IF; TX_IF) outputted as common mode from the transmission IF VCO 42 and the base band signal transmitted from the base band module 30. Transmission IF AGC 44 is for automatically controlling the magnitude of the IF transmission signal outputted from the transmission IF mixer 43.

Tri-mode RF transmission processing unit 50 includes a first transmission RF mixer 51, a first driving amplifier 52, a first power amplifier 53, a second transmission RF mixer 54, a second driving amplifier 55, and a second power amplifier 56. First transmission RF mixer 51 is for mixing the IF transmission signal of the DCN mode outputted from the transmission IF AGC 44 of the tri-mode IF transmission processing unit 40 and the carrier frequency outputted from the first RF VCO 61. First driving amplifier 52 is for amplifying the RF transmission signal of the DCN mode outputted from the first transmission RF mixer 51. First power amplifier 53 is for amplifying an electric power of the RF transmission signal of the DCN mode outputted from the first driving amplifier. Second transmission RF mixer 54 is for mixing the IF transmission signal of the PCS mode outputted from the transmission IF AGC 44 and the carrier frequency outputted from the second RF VCO 62. Second driving amplifier 55 is for amplifying the RF transmission signal of the PCS mode outputted from the second transmission RF mixer 54. Second power amplifier 56 is for amplifying the electric power of the RF transmission signal of the PCS mode outputted from the second driving amplifier 55.

FIG. 2 illustrates a method for designing the local frequency used in the respective components of the background tri-mode mobile terminal. In block S1, a transmitting/receiving frequency of the AMPS/CDMA mode (DCN mode) and a transmitting/receiving frequency of the PCS mode are allocated according to international standards (IS-95A, B, and C). For example, the transmitting/receiving frequency of the DCN mode is allocated to be used in 800 MHz band and the transmitting/receiving frequency of the PCS mode is allocated to be used in 1.5 GHz-1.8 GHz band.

A transmission IF, which is commonly used in the tri-mode terminals is set in block S2. For example, the transmission IF may be set as 130.38 MHz. In block S3, the carrier frequencies of the respective modes (carrier frequencies of DCN mode and the PCS mode) are calculated using the set transmission IF and the transmission frequencies of the respective modes allocated in the block S1.

The receive IF (DCN_RX_IF) of the DCN mode is calculated using the calculated DCN carrier frequency (DCN_UHF; DCN Ultra High Frequency) and the receive frequency of the DCN mode allocated in the block S1. The receive IF (PCS_RX_IF) of the PCS mode is calculated using the PCS carrier frequency (PCS_UHF) and the allocated receive frequency of the PCS mode calculated in block S4.

The local frequency, used by the hardware components of a tri-mode mobile terminal, is the base band signal for transmission. The base band signal is mixed with the transmission IF regardless of the mode and is changed to a IF transmission signal during a transmission operation of a tri-mode mobile terminal. The IF transmission signal in DCN mode is mixed with the carrier frequency of the DCN mode and transformed to a RF transmission signal. The IF transmission signal in PCS mode is mixed with the carrier frequency of the PCS mode and transformed to a RF transmission signal.

During a receiving operation of the tri-mode mobile terminal, the RF receive signal in DCN mode is mixed with the carrier frequency of the DCN mode and transformed into an IF receive signal. The RF receive signal in PCS mode is mixed with the carrier frequency of the PCS mode and transformed into an IF receive signal. The IF receive signal of the DCN mode is mixed with the IF (DCN_RX_IF) of the DCN mode and transformed to a base band signal. The IF receive signal of the PCS mode is mixed with the IF (PCS_RX_IF) of the PCS mode and transformed to the base band signal.

The apparatus for processing the radio frequency described above should generate different carrier frequencies used when the RF receive signal is transformed to the IF receive signal according to the DCN mode and the PCS mode. Therefore there should be an RF VCO for generating the carrier frequency of DCN mode and an RF VCO for generating the carrier frequency of the PCS mode. Accordingly, the above-described background art apparatus has the disadvantage of needing more than one voltage controlled oscillator to accommodate for DCN mode and PCS mode. This disadvantage contributes to the complexity and bulkiness of a tri-mode terminal having this feature.

The above references are incorporated by reference herein, where appropriate, for appropriate teachings of additional or alternative details, features and/or technical background.

### SUMMARY OF THE INVENTION

The above-mentioned disadvantages of the background art are alleviated by aspects of the present invention. Particularly, the present invention uses the same oscillator for all the different modes of the different wireless networks in a mobile terminal. Using the same oscillator reduces the size and weight of a mobile terminal of the present invention. Accordingly, the present invention is advantageous as it is lighter and therefor more mobile than the mobile terminal described in the background art. Further, the mobile terminal of the present invention is simplified by requiring a single oscillator for different communication modes. This improves reliability of the mobile terminal of the present invention.

Embodiments of the present invention relate to an apparatus comprising a first mixer, a second mixer, an oscillator, and a frequency divider. The oscillator is coupled to the first mixer. The frequency dividers comprise an input and output. The input of the divider is coupled to the oscillator and the output of the divider is coupled to the second mixer. In embodiments of the present invention, the signal is a radio frequency signal, the oscillator is a voltage controlled oscillator, the frequency divider divides frequencies in half, and the apparatus is configured for processing a signal in a tri-mode mobile terminal. In embodiments of the present invention the apparatus comprises at least one automatic gain controller coupled to the at least one processor.

In embodiments of the present invention, the apparatus is configured to transmit or receive a first signal type and a second signal type. The first signal type carries data in a first communication protocol. The first mixer is configured according to the carrier frequency of the first signal type. The second signal type carries data in a second communication protocol. The second mixer is configured to the carrier frequency of the second signal type. In embodiments of the present invention, the carrier frequency of the first signal type is approximately twice the carrier frequency of the second signal type. In embodiments of the present invention, the first communication protocol may be Advance Mobile Phone System service mode, Code Division Multiple Access service mode, or Digital Communication Network mode. In embodiments of the present invention, the second communication protocol is Personal Communication System mode.

Embodiments of the present invention are methods that comprises the following steps: Driving a first mixer at a first frequency with an oscillator. Driving a second mixer at a second frequency with the oscillator and a frequency divider. Transmitting or receiving a signal at the first mixer. Transmitting or receiving the signal at the second mixer. In embodiments, the second frequency is approximately half of the first frequency.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram showing an example of a background art apparatus for a radio frequency signal in a tri-mode mobile terminal;

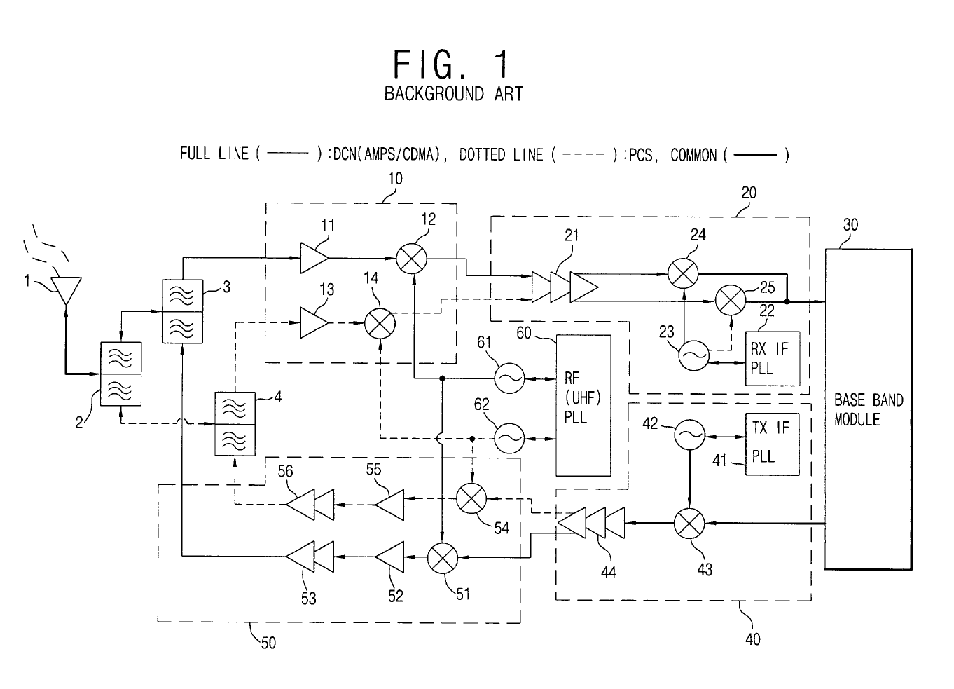

FIG. 2 is a flow chart showing a designing method for a carrier frequency/intermediate frequency used in a background art tri-mode mobile terminal;

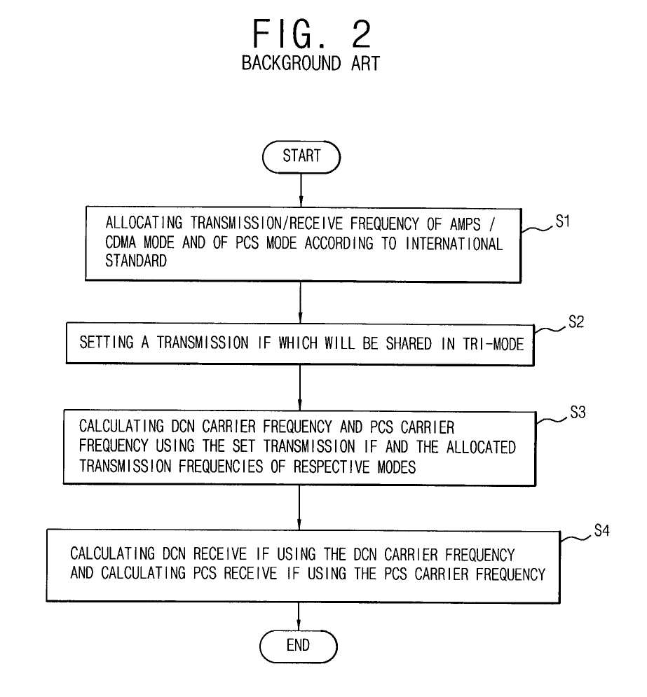

FIG. 3 is a block diagram showing an apparatus for processing a radio frequency signal in a tri-mode mobile terminal according to embodiments of the present invention;

FIG. 4 is a flow chart showing a designing method of a carrier frequency/intermediate frequency used in a tri-mode mobile terminal according to embodiments of the present invention;

FIG. 5a is a flow chart showing a method for receive processing a radio frequency signal in a tri-mode mobile terminal according to embodiments of the present invention; and

FIG. 5b is a flow chart showing a method for transmission processing a radio frequency signal in a tri-mode mobile terminal according to embodiments of the present invention.

### DETAILED DESCRIPTION OF PREFERRED EMBODIMENTS

Reference will now be made in detail to the preferred embodiments of the present invention, examples of which are illustrated in the accompanying drawings.

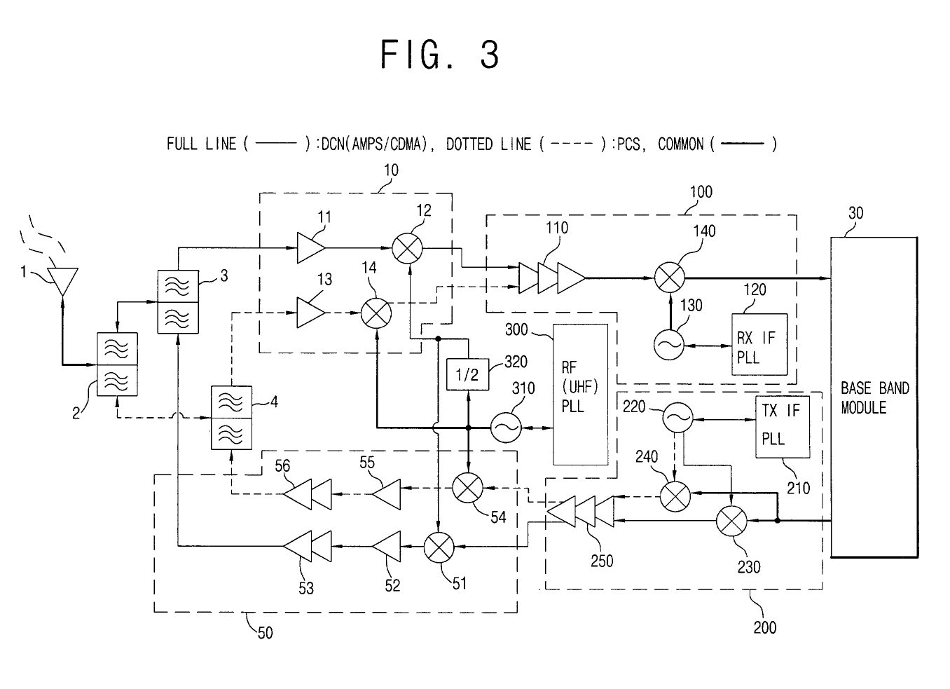

FIG. 3 illustrates a structure of an apparatus for processing a radio frequency signal in a tri-mode mobile terminal according to embodiments of the present invention. The apparatus includes an antenna 1, a separator 2, a DCN duplexer 3, a PCS duplexer 4, a tri-mode RF receive processor 10, a tri-mode IF receive processor 100, a base band module 30, a tri-mode IF transmission processor 200, a tri-mode RF transmission processor 50, a RF voltage controlled oscillator (VCO) 310, a RF phase lock loop (PLL) 300, and a divider 320. Separator 2 is for separating a radio frequency signal for communicating with the antenna 1 according to a DCN mode (AMPS mode/CDMA mode) and a PCS (Personal Communication System) mode. DCN duplexer 3, connected to the separator 2, is for separating a RF transmission signal and RF receive signal of the DCN mode. PCS duplexer 4, connected to the separator 2, is for separating a RF transmission signal and RF receive signal of the PCS mode.

Tri-mode RF receive processor 10 receives an RF signal of the DCN (Digital Communication Network) mode and an RF signal of the PCS mode separated in the separator 2. Tri-mode IF receive processor 100 transforms an IF receive signal which is transformed to a lower frequency in the tri-mode RF receive processor 10 into a base band signal, regardless of the mode. Base band module 30 transforms an analog base band signal transmitted from the tri-mode IF receive processor 100 into a digital signal. Tri-mode IF transmission processor 200 transforms the analog base band signal transmitted from the base band module 30 into an IF transmission signal according to the DCN mode and the PCS mode. Tri-mode RF transmission processor 50 transforms the IF transmission signal processed in the tri-mode IF transmission processor 200 into an RF transmission signal according to the DCN mode and the PCS mode.

RF VCO 310 provides the tri-mode RF receive processor 10 and the tri-mode RF transmission processor 50 with a carrier frequency according to the PCS mode. The RF PLL 300 controls the RF VCO 310 so that an output frequency of the RF VCO 310 is operated at a certain phase angle. The divider 320 divides the carrier frequency of the PCS mode outputted from the RF VCO 310 in half.

Tri-mode IF receive processor 100 includes RF IF AGC (Automatic Gain Controller) 110, RX IF VCO 130, RX IF PLL 120, and RX IF mixer 140. RX IF AGC (Automatic Gain Controller) 110 is for automatically controlling the magnitude of an IF receive signal of the DCN mode and an IF receive signal of the PCS mode which are outputted from a first receive RF mixer 12 and a second receive RF mixer 14 in the tri-mode RF receive processor 10. RX IF VCO 130 is for outputting the IF receive signal outputted from the RX IF AGC 110 into an analog base band signal which is common to different modes. RX IF PLL 120 is for controlling the RX IF VCO 130 so that an output frequency (RX_IF) of the RX IF VCO 130 is operated at a predetermined phase angle. RX IF mixer 140 is for mixing the IF receive signal of the tri-mode terminal outputted from the RX IF AGC 110 and the IF (RX_IF) of common mode outputted from the RX IF VCO 130.

The tri-mode IF transmission processor 200 includes a TX IF VCO 220, a TX IF PLL 210, a first transmission IF mixer 230, a second transmission IF mixer 240, and a transmission IF AGC 250. TX IF VCO 220 is for outputting an IF for transforming the base band signal transmitted from the base band module 30 into an IF transmission signal according to all modes. TX IF PLL 210 is for controlling the TX IF VCO 220 so that output frequencies DCN_TX_IF and PCS_TX_IF are according to the mode of the TX IF VCO 220 and are operated within a certain phase angle. First transmission mixer 230 is for mixing the DCN_TX_IF outputted from the TX IF VCO 220 and the base band signal of the DCN mode transmitted from the base band module 30. Second transmission IF mixer 240 is for mixing the PCS_TX_IF outputted from the TX IF VCO 220 and the base band signal of the PCS mode transmitted from the base band module 30. Transmission IF AGC 250 is for automatically controlling the magnitude of the IF transmission signal outputted from the first and the second transmission mixers 230 and 240.

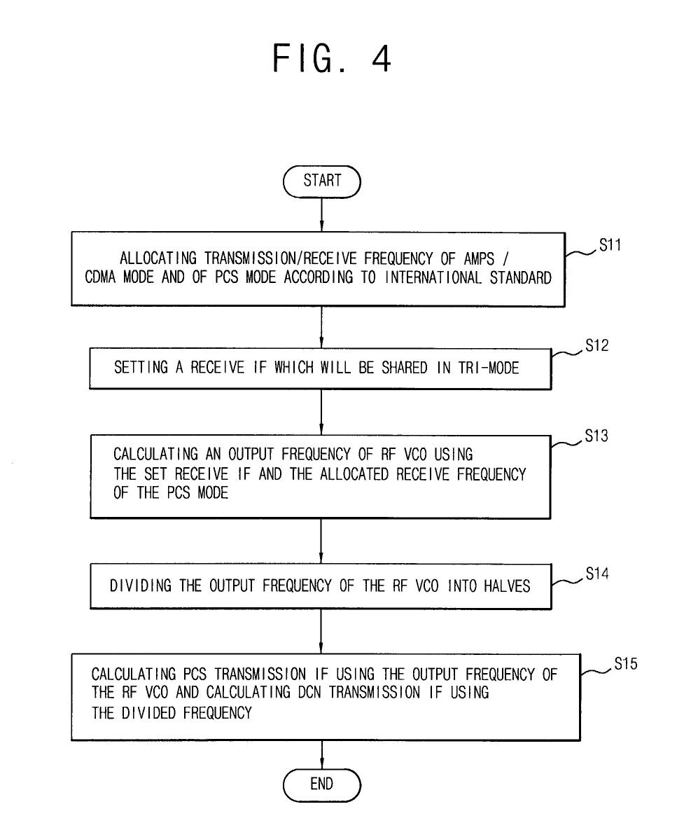

FIG. 4 illustrates a method for designing inner frequencies used in components of a tri-mode mobile terminal according to embodiments of the present invention. It is shown in block S11 that transmission/receive frequency of the AMPS/CDMA modes (DCN mode) and the transmission/receive frequency of the PCS mode are allocated according to international standards (IS-95A, IS-95B, and IS-95C). For example, a frequency of 800 MHz band is allocated to the transmission/receive frequency of the DCN mode and a frequency of 1.5 GHz-1.8 GHz band is allocated to the transmission/receive frequency of the PCS mode.

The transmission/receive frequency of the PCS mode is approximately twice as large as the DCN mode. In the embodiments of the present invention a receive IF (RX_IF) is driven by the same RF VCO for the DCN mode and in the PCS mode. For example, the receive IF is set at 183.6 MHz.

In block S13, the output frequency of the RF VCO is calculated using the RX_IF set in block S12 and the receive frequency of the PCS mode allocated in the block of S11. In block S14, the output frequency of the RF VCO is divided in half. Accordingly, these aspects of the present invention allow for the IF VCO to drive a carrier frequency for both the PCS mode and the DCN mode because the carrier frequency of the DCN mode is approximately half of the carrier frequency of the PCS mode. PCS_TX_IF is calculated using the output frequency of the RF VCO and the transmission frequency allocated in block S11. In block S15, the DCN_TX_IF is calculated using the divided frequency from block S14 and the transmission frequency allocated in block S11.

Accordingly, the local frequency used in the apparatus for processing the radio frequency is designed such that one RF VCO can be shared in tri-mode operation. The output frequency of the RF VCO is used when the receive frequency of the PCS mode is transformed to a lower frequency or the transmission frequency is transformed to a higher frequency. Likewise, the divided frequency is used when the receive frequency is transformed to a lower frequency or when the transmission frequency of the DCN mode is transformed to a higher frequency.

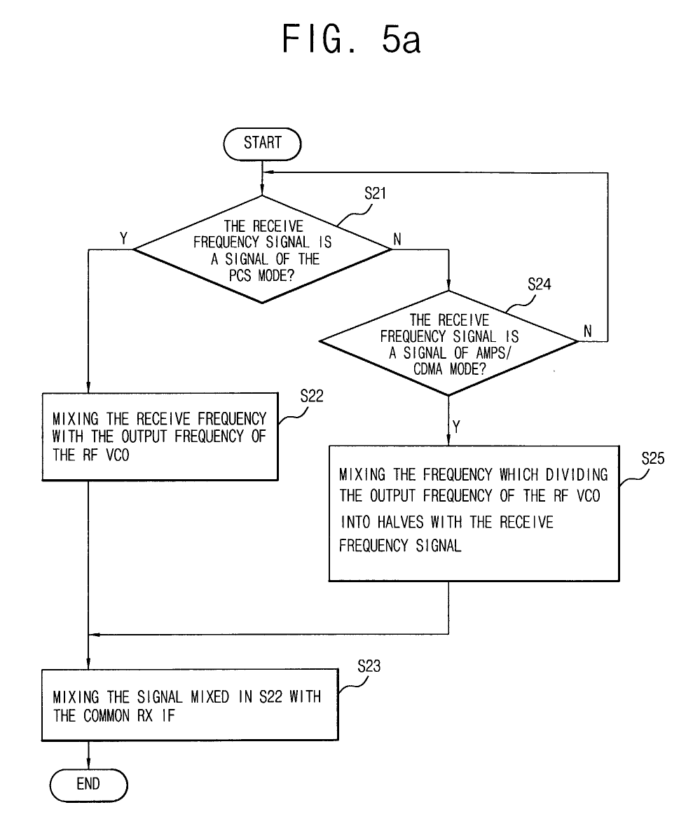

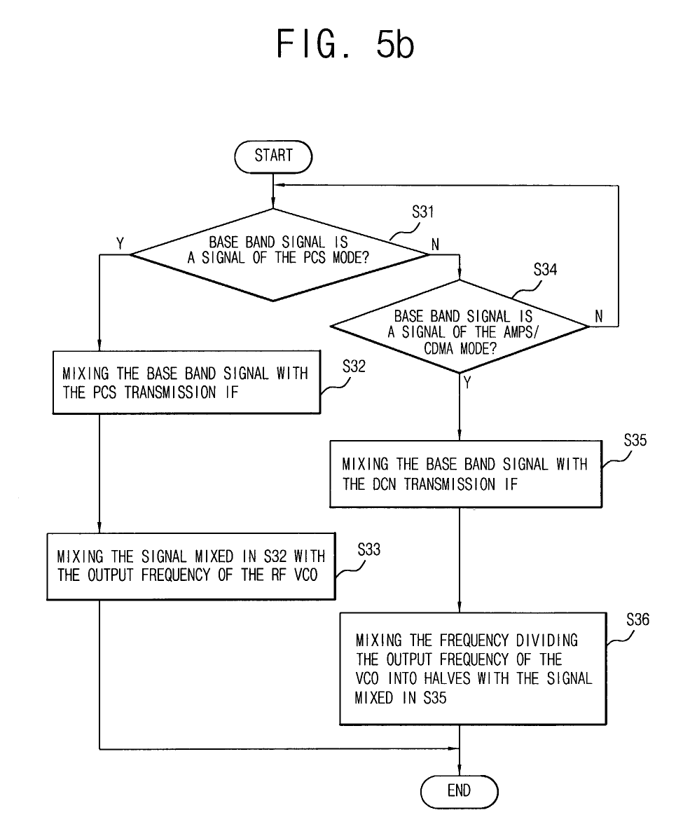

FIG. 5a illustrates a receiving method of an apparatus for processing the radio frequency in the tri-mode mobile terminal according to embodiments of the present invention.

In blocks S21 and S22, a RF receive signal of the PCS mode is mixed with the output frequency (carrier frequency) of the RF VCO 310 and transformed into the IF receive signal. In blocks S24, a RF receive signal of the DCN mode is mixed with the frequency output from divider 320 to generate an IF receive signal. In block S25, IF receive signal is mixed with the output frequency (RX_IF) of the RX IF VCO 130 and transformed into a base band signal. In other words, the IF receive signal of both the DCN mode and the PCS mode are mixed with the output frequency (RX_IF) of the RX IF VCO 130 and transformed into the base band signal.

FIG. 5b illustrates a transmission method of an apparatus for processing the radio frequency in the tri-mode mobile terminal according to embodiments of the present invention. In blocks S31 and S32, the base band signal of the PCS mode transmitted from the base band module 30 is mixed with the TX IF of the PCS mode (PCS_TX_IF) and transformed into the IF transmission signal. In blocks S34 and S35, the base band signal of the DCN mode is mixed with the TX IF of the DCN mode (DCN_TX_IF) and transformed into the IF transmission signal. In block S33, the IF transmission signal of the PCS mode is mixed with the output frequency of the RF VCO 310 and transformed into the RF transmission signal. In block S36, the IF transmission signal of the DCN mode is mixed with the frequency which is made by dividing the output frequency of the RF VCO 310.

The transmission/receive operations of the apparatus for processing the radio frequency in the tri-mode mobile terminal according to embodiments of the present invention is discussed below in additional detail.

(A) Receiving a Signal of the DCN Mode

As shown in FIG. 3, the RF signal inputted from the antenna 1 is separated into the RF signal of the DCN mode and the RF signal of the PCS mode by the separator 2, the RF signal of the DCN mode is transmitted to the first LNA 11 in the tri-mode RF receive processor 10 through the DCN duplexer 3. For example, RF signal of the DCN mode (DCN_RX_frequency) is defined as follows, according to the IS-95A (IS-95B or IS-95C) specification. 869,040+(((ch+32)/1023)*30)(KHz) (1≦ch≦1023) [Equation 1]

In the above equation, ch means a channel of the DCN mode. A channel has band width of 30 KHz.

The receive IF (RX_IF) is set as 183.6 MHz so as to be used in the DCN mode and the PCS mode in common, and therefore the carrier frequency of the DCN mode can be calculated as the following second equation using the receive frequency of the DCN mode defined as the first equation.

1,052,640+(((ch+32)/1023)*30)(KHz) (1≦ch≦1023) [Equation 2]

Therefore, the output frequency of the RF VCO 310 can be calculated as the following third equation.

2,105,280+(((ch+32)/1023)*60)(KHz) (1≦ch≦1023) [Equation 3]

The first RX mixer 12 mixes the RF receive signal of the DCN mode outputted from the first LNA 11 and the carrier frequency of the second equation outputted from the divider 320, and then outputs the IF receive signal of 183,600 KHz. The RX IF mixer 140 mixes the IF receive signal with the receive IF (RX_IF) of 183,600 KHz outputted from the RX IF VCO 130, and then transforms the IF receive signal into the base band signal which is outputted to the base band module 30.

(B) Transmission of a Signal of the DCN Mode

As shown in FIG. 3, the TX IF VCO 220 outputs the transmission IF of the DCN mode of 228,600 KHz, and the first TX IF mixer 230 mixes the base band signal of the DCN mode transmitted from the base band module 30 with the transmission IF of 228,600 KHz, and then outputs the IF transmission signal of 228,600 KHz. The TX IF AGC 250 automatically controls the magnitude of the IF transmission signal and outputs it to the tri-mode RF transmission processor 50.

The first TX RF mixer 51 of the tri-mode RF transmission processor 50 subtracts the IF transmission signal from the carrier frequency of the DCN mode outputted from the divider 320 (frequency calculated by the second equation), and outputs the RF transmission signal calculated as follows.

824,040+(((ch+32)/1023)*30)(KHz) (1≦ch≦1023) [Equation 4]

The first driving amplifier 52 amplifies the RF transmission signal outputted from the first TX RF mixer 51 and the first power amplifier 53 amplifies the electric power of the RF transmission signal outputted from the first driving amplifier 52. The DCN duplexer 3 transmits the amplified RF transmission signal of the DCN mode to the separator 2. Therefore, the RF transmission signal is passed through the separator 2 and transmitted to a base station through the antenna 1.

According to the method and the apparatus of the present invention described herein, the circuit structure of a tri-mode mobile terminal can be simplified. Accordingly, tri-mode mobile terminals of the present invention can be built having a smaller size and a lower overall weight.

In summary, the present invention relates to a method and apparatus including a first mixer, a second mixer, an oscillator, and a frequency divider. The oscillator is coupled to the first mixer. The frequency divider comprises an input and an output. The input of the divider is coupled to the oscillator and the output of the divider is coupled to the second mixer. These embodiments are advantageous, as a single oscillator can be used for both the first and second mixer.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An apparatus comprising:
a first mixer for processing a signal;
a second mixer;
an oscillator coupled to said first mixer; and
a frequency divider comprising an input and an output, wherein the input of the divider is coupled to the oscillator and the output of the divider is coupled to the second mixer.

2. The apparatus of claim 1, wherein the signal is a radio frequency signal.

3. The apparatus of claim 1, wherein the oscillator is a voltage controlled oscillator.

4. The apparatus of claim 1, wherein the frequency divider divides frequencies in half.

5. The apparatus of claim 1, wherein the apparatus is configured for processing a signal in a tri-mode mobile terminal.

6. The apparatus of claim 1, wherein the apparatus is configured to transmit or receive a first signal type and a second signal type, wherein:
the first signal type carries data in a first communication protocol;
the first mixer is configured according to a carrier frequency of the first signal type;
the second signal type carries data in a second communication protocol; and
the second mixer is configured to a carrier frequency of the second signal type.

7. The apparatus of claim 6, wherein the carrier frequency of the first signal type is approximately twice the carrier frequency of the second signal type.

8. The apparatus of claim 6, wherein:
the first communication protocol is at least one of Advanced Mobile Phone System service mode, Code Division Multiple Access service mode, and Digital Communication Network mode; and
the second communication protocol is Personal Communication System mode.

9. The apparatus of claim 1, further comprising at least one automatic gain controller.

10. A method comprising:
driving a first mixer at a first frequency with an oscillator;
driving a second mixer at a second frequency with the oscillator and a frequency divider, wherein second frequency is approximately half of the first frequency;
transmitting or receiving a signal at the first mixer; and
transmitting or receiving the signal at the second mixer.

11. The method of claim 10, wherein the signal is a radio frequency signal.

12. The method of claim 10, wherein the oscillator is a voltage controlled oscillator.

13. The method of claim 10, wherein the method is processing a signal in a tri-mode mobile terminal.

14. The method of claim 10, wherein:
a first signal type and a second signal type can be transmitted or received;
the first signal type carries data in a first communication protocol;
the first mixer is configured according to a carrier frequency of the first signal type;
the second signal type carries data in a second communication protocol; and
the second mixer is configured to a carrier frequency of the second signal type.

15. The method of claim 14, wherein the carrier frequency of the first signal type is approximately twice the carrier frequency of the second signal type.

16. The method of claim 14, wherein:
the first communication protocol is at least one of Advanced Mobile Phone System service mode, Code Division Multiple Access service mode, and Digital Communication Network mode; and
the second communication protocol is Personal Communication System mode.

17. The method of claim 10, further comprising a step of automatically controlling the gain of a signal output from the first mixer or the second mixer.

18. A mobile terminal comprising:
a first mixer;
a second mixer;
a single oscillator; and
a means for producing carrier frequencies for the first mixer and the second mixer with the single oscillator, wherein the carrier frequency of the first mixer is approximately twice the carrier frequency of the single oscillator.

19. The mobile terminal of claim 18, wherein the means comprises a frequency divider.

20. The mobile terminal of claim 18, wherein:
the carrier frequency of the first mixer is according to Personal Communication System mode; and
the carrier frequency of the second mixer is according to at least one of Advanced Mobile Phone System service mode, Code Division Multiple Access service mode, and Digital Communication Network mode.
